(19) United States
(12) Patent Application Publication
(10) Pub. No.: US 2026/0078033 A1
(43) Pub. Date: Mar. 19, 2026

(54) METHOD OF OPERATION FOR IN-FIELD ANTIMICROBIAL REGULATION AND VALIDATION SYSTEM FOR IRRIGATION SYSTEM

(71) Applicant: KiVAR Chemical Technologies, Bakersfield, CA (US)

(72) Inventors: Richard Varley, Bakersfield, CA (US); Kevin Varley, Bakersfield, CA (US)

(21) Appl. No.: 19/296,251

(22) Filed: Aug. 11, 2025

Related U.S. Application Data
(60) Provisional application No. 63/694,508, filed on Sep. 13, 2024.
(60) Provisional application No. 63/694,442, filed on Sep. 13, 2024.

(51) Int. Cl. C02F 1/76; C02F 1/00; C02F 103/02

(52) U.S. Cl. CPC C02F 1/76; C02F 1/008; C02F 2103/02; C02F 2209/001; C02F 2209/006; C02F 2209/008; C02F 2303/04

(57) ABSTRACT

Embodiments of the present invention provide system and methods for treating irrigation water with antimicrobial agents that can automatically control one or more dosing pumps based on sensor data to maintain antimicrobial levels within a predetermined range using one or more sensors. Typically the sensor data is generated in real-time by amperometric sensors and/or a water meter disposed downstream of the base treatment system that can measure antimicrobial levels, water flow rate, etc. According to some embodiments, a control unit communicates wirelessly with the pumps and sensors and generates control signals based on configuration parameters (e.g., desired antimicrobial levels, scheduling, etc.) and sensor data (e.g., ppm, gpm, etc.) to control the dosing pumps. The antimicrobial level (residual) can be validated at various points throughout the irrigation system according to real-time sensor data.

### CROSS-REFERENCE TO RELATED APPLICATIONS

This application claims the benefit of and priority to U.S. Provisional Patent Application No. 63/694,508 filed on Sep. 13, 2024, and to U.S. Provisional Patent Application No. 63/694,442 filed on Sep. 13, 2024, the contents of which are hereby incorporated by reference in their entirety.

### FIELD

Embodiments of the present invention generally relate to the field of irrigation. More specifically, embodiments of the present invention relate to systems and methods for monitoring and controlling the content and conditions of water used by irrigation systems.

### BACKGROUND

Irrigation systems are commonly used in agriculture to supply fields with water and nutrients to support healthy crop growth. While these systems are often essential for large-scale crop production, they can be prone to microbial contamination, which can negatively impact crop health and poses a danger to consumers. For this reason, chemicals (e.g., antimicrobial agents) are added to the irrigation water supply to prevent out of control microbial growth for food safety. Peracetic acid (PAA) is one commonly used antimicrobial chemical. Chlorine dioxide, liquid or solid chlorine without pH control, and chlorine with pH control are other suitable examples. The use of these chemicals is also mandated by certain agreements such as the California Leafy Greens Marketing Agreement (CLGMA) and the Arizona Leafy Greens Marketing Agreement (ALGMA). However, the lack of real-time monitoring and precise regulation of dosing can lead to overuse or underuse of these chemicals, significantly impacting both the environment, crop yield, and food safety. Therefore, it is critically important to monitor the amount of antimicrobial agent present in the water supply and to verify that conditions fall within a specific range of acceptable values over time. Unfortunately, current systems are unable to sufficiently regulate and validate content and conditions of the irrigation water supply in real-time, especially at large scales. Therefore, modern irrigation systems typically require manually measuring the amount of antimicrobial agent present in the irrigation water using time consuming and laborious techniques that fail to scale adequately to address the needs of large-scale modern agricultural operations. These manual techniques typically involve an employee manually checking the water using a dipstick testing device to determine water content and conditions.

Moreover, modern irrigation systems often include a complex series of lengthy lines (e.g., pipes, irrigation channels, etc.) that can extend dozens of yards or even miles before reaching an outlet or sprinkler that releases the water into the field. In these cases, the conditions of water at different sections of an irrigation line may be very different with respect to concentration of antimicrobial agents. For example, when certain chemical additives are supplied to the irrigation water, the microbes present in the water may consume or otherwise deplete a significant portion of the additive such that the additive is greatly diminished before the water reaches an outlet. As such, it is presently difficult to monitor and adjust the additives used in irrigation systems to control microbial content in the water supply when accommodating different lines or line sections within a large-scale irrigation system in real-time.

For these reasons, an improved approach to automatic antimicrobial regulation and validation is desired.

### SUMMARY

Accordingly, embodiments of the present invention provide system and methods for treating irrigation water with antimicrobial agents that can automatically control one or more dosing pumps based on sensor data to maintain antimicrobial levels within a predetermined range using one or more sensors. Typically the sensor data is generated in real-time by amperometric sensors disposed downstream of the base treatment system that can measure antimicrobial levels, water meters that can measure water flow rate, etc. According to some embodiments, a control unit communicates with the pumps and sensors and generates control signals based on configuration parameters (e.g., desired antimicrobial levels, scheduling, etc.) and sensor data (e.g., ppm, gpm, etc.) to control the dosing pumps. The antimicrobial level (residual) can be validated at various points throughout the irrigation system according to real-time sensor data. Components located in close proximity to the base station can be wired, while more remote components typically communicate wirelessly using one or more radios.

According to one disclosed embodiment, a method of automatically treating irrigation water using an antimicrobial agent is disclosed. The method includes receiving sensor data from an amperometric sensor disposed at a location within an irrigation system, the amperometric sensor operable to indicate an antimicrobial residual of irrigation water flowing through the location of the irrigation system, generating a control signal for controlling a first dosing pump to release an antimicrobial agent based on the sensor data, and transmitting the control signal to the first dosing pump to control a function of the first dosing pump. The amperometric sensor is downstream from the first dosing pump within the irrigation system.

According to some embodiments, the amperometric sensor is disposed upstream of a first sprinkler of the irrigation system.

According to some embodiments, the method includes validating the antimicrobial residual of the irrigation water based on the sensor data.

According to some embodiments, the method includes storing the sensor data in memory and validating the antimicrobial residual of the irrigation water based on remote sensor data generated by a remote amperometric sensor.

According to some embodiments, the remote amperometric sensor is disposed downstream of a last sprinkler of the irrigation system.

According to some embodiments, the antimicrobial agent comprises peracetic acid (PAA), wherein the amperometric sensor comprises a PAA amperometric sensor.

According to some embodiments, the antimicrobial agent comprises chlorine dioxide.

According to some embodiments, the method includes receiving water flow rate data from a water meter indicating a water flow rate of the irrigation water, and generating another control signal for controlling a second dosing pump according to the water flow rate data.

According to some embodiments, the generating a control signal for controlling a first dosing pump based on the sensor data includes controlling the first dosing pump to release a relatively small amount of the antimicrobial agent periodically.

According to some embodiments, the generating another control signal for controlling a second dosing pump according to the water flow rate includes continuously releasing the antimicrobial agent at a rate proportionate to the water flow rate.

According to some embodiments, the method includes storing historical water treatment data including at least one of: the control signal; and the sensor data, aggregating the historical water treatment data with existing historical water treatment data, and analyzing the historical data to identify a trend corresponding to antimicrobial levels of the irrigation water.

According to some embodiments, the method includes generating a modified control signal for controlling the first dosing pump to release an antimicrobial agent based on new sensor data generated by the amperometric sensor and the trend.

According to another embodiment, a method of automatically treating water for irrigation using an antimicrobial agent is disclosed. The method includes receiving first sensor data from a first sensor operable to indicate an antimicrobial residual of irrigation water flowing through an irrigation system at a location of the first sensor, receiving second sensor data from a second sensor operable to indicate a water flow rate of the irrigation water at a location of the second sensor, generating a first control signal for controlling the first dosing pump to release an antimicrobial agent based on the antimicrobial residual as measured by the first sensor, and generating a second control signal for controlling the second dosing pump to release an antimicrobial agent based on the water flow rate as measured by the second sensor.

According to some embodiments, the method includes storing the antimicrobial residual in memory and validating the antimicrobial residual based on the first sensor data.

According to some embodiments, the method includes validating the antimicrobial residual based on remote sensor data generated by a remote sensor indicating a remote antimicrobial residual level.

According to some embodiments, the method includes receiving a target antimicrobial level as input. The generating the first control signal and the generating the second control signal includes generating control signals that alter the amount of antimicrobial agent released by the first dosing pump and the second dosing pump to achieve the target antimicrobial level.

According to some embodiments, the receiving a target antimicrobial level as input includes receiving a range of acceptable antimicrobial levels.

According to some embodiments, the method includes triggering an alarm according to at least one of: the first sensor data; and the second sensor data.

According to another embodiment, a method of automatically treating water for irrigation based on historic treatment data is disclosed. The method includes performing an automatic water treatment process comprising automatically controlling a dosing pump based on real-time sensor data indicating a level of antimicrobial residual flowing through an irrigation system, storing data generated by the automatic water treatment process, aggregating the data generated by the automatic water treatment process with historical water treatment data, and analyzing the historical water treatment data to determine a trend corresponding to dosing pump control commands and the real-time sensor data.

According to some embodiments, the method includes receiving new real-time sensor data and controlling the dosing pump using control commands generated according to the trend and the new real-time sensor data.

According to some embodiments, the method includes receiving new real-time sensor data and triggering an alarm according to the trend and the new real-time sensor data.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram depicting an exemplary automatic antimicrobial treatment and validation system operable to treat an irrigation water supply to prevent uncontrolled microbial growth in-field according to embodiments of the present invention.

FIG. 2 is a diagram depicting an exemplary automatic antimicrobial treatment and validation system including two dosing pumps and a water meter according to embodiments of the present invention.

FIG. 3 is a data flow diagram depicting an exemplary antimicrobial treatment system for controlling antimicrobial levels in an irrigation system according to embodiments of the present invention.

FIG. 4 is a flowchart depicting steps of an exemplary process for automatically treating water for irrigation using an antimicrobial agent released by a dosing pump in accordance with real-time sensor data according to embodiments of the present invention.

FIG. 5 is a flowchart depicting steps of an exemplary process for automatically treating water for irrigation using an antimicrobial agent released by two dosing pumps in accordance with real-time sensor data, including the water flow rate and antimicrobial residual levels according to embodiments of the present invention

FIG. 6 is a flowchart depicting steps of an exemplary process for automatically treating water for irrigation based on historical water treatment data according to embodiments of the present invention.

FIG. 7 is block diagram of an exemplary computer system platform upon which embodiments of the present invention can be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

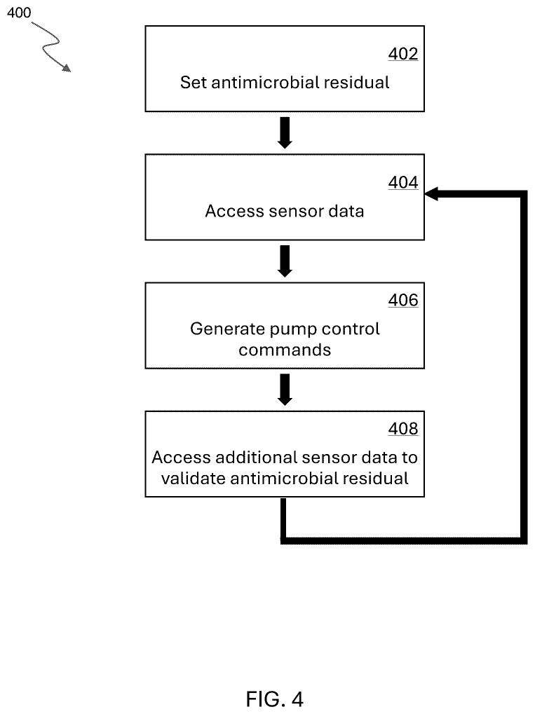

Portions of the detailed description that follows are presented and discussed in terms of a method. Although steps and sequencing thereof are disclosed in a figure herein describing the operations of this method (e.g., FIGS. 4-6), such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “associating,” “identifying,” “encoding,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Method of Operation for In-Field Antimicrobial Regulation and Validation System for Irrigation System with Historical Data Preservation and Display

Embodiments of the present invention provide systems and methods for treating irrigation water with antimicrobial agents that can automatically control one or more dosing pumps based on sensor data to maintain antimicrobial levels within a predetermined range using one or more sensors of the irrigation water. Typically the sensor data is generated in real-time by amperometric sensors and/or a water meter disposed downstream of the base treatment system that can measure antimicrobial levels, water flow rate, etc. According to some embodiments, a control unit communicates wirelessly with the pumps and sensors and generates control signals based on configuration parameters (e.g., desired antimicrobial levels, scheduling, etc.) and sensor data (e.g., ppm, gpm, etc.) to control the dosing pumps. The antimicrobial level (residual) can be recorded and thereby validated at various points throughout the irrigation system according to real-time sensor data.

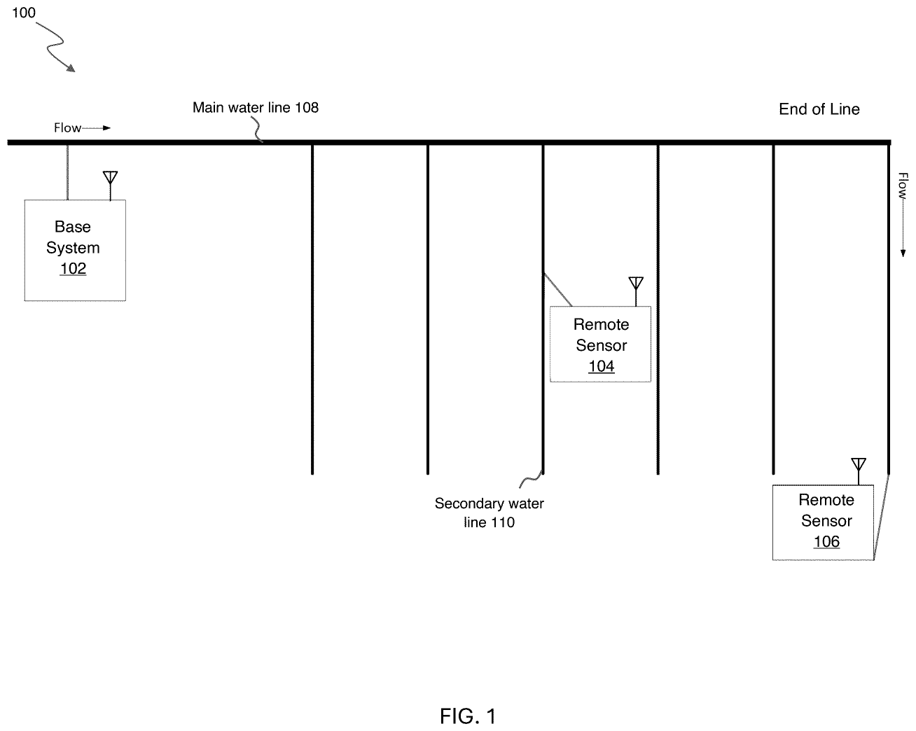

FIG. 1 is a diagram depicting an exemplary antimicrobial treatment system 100 for use with an irrigation system according to embodiments of the present invention. Irrigation system 100 typically includes a main water line or open duct/canal and one or more branching water lines. Advantageously, antimicrobial treatment system 100 can automatically dose, monitor, and validate the treatment and condition of the irrigation water, including the real-time amount of antimicrobial agent present in the water supply at various locations over time throughout the irrigation system, including various lines, pipes, ducts, canals, etc. In this way, the amount of antimicrobial agent can be maintained within a desired limit over time using automated techniques that can be scaled to accommodate the demands of large-scale modern agriculture.

Antimicrobial treatment system 100 typically includes a small container or tank that stores an antimicrobial agent and a dosing pump that applies a controlled dose of antimicrobial agent to the irrigation water. A sensor downstream from the dosing pump monitors the amount of antimicrobial agent present in the water at the downstream location of the sensor. The dosing pump and the sensor are in communication (e.g., wireless communication) with a control unit that controls the dosing pump, for example, according to the reading of the sensor or according to the flow rate of the water line. The sensor can be an amperometric sensor in one embodiment such as peracetic acid (PAA) amperometric sensor, although any suitable sensor (e.g., chlorine dioxide or free chlorine) can be used.

In the example of FIG. 1, antimicrobial treatment system 100 includes a base treatment system 102 and two optional remote monitoring units 104, 106 disposed at different locations of the irrigation system to monitor the condition of the irrigation water carried by the irrigation lines. Remote monitoring unit 104 includes an intermediate sensor disposed roughly in the middle of the irrigation system on secondary water line 110, and remote monitoring unit 106 includes an end of line sensor disposed after the last sprinkler or outlet of the irrigation system 100. Remote monitoring unit 104 can also be disposed in the trunk line downstream of base system 102, although base system 102 can include its own sensor, according to embodiments. In this way, antimicrobial treatment system 100 can determine the extent to which antimicrobial agents added to the water of the main water line 108 at the base treatment system 102 are consumed or depleted at various points of the irrigation system in real-time. The antimicrobial agent can be peracetic acid, chlorine, or any other oxidant suitable for treating water applied to fields of leafy greens or other vegetation, for example.

Importantly, antimicrobial treatment system 100 can automatically adjust the amount of antimicrobial agent added to the irrigation water at any time. For example, the amount of antimicrobial agent can be increased or decreased manually, or set to a specific range of values that is automatically maintained using one or more dosing pumps. Moreover, an alarm or other notification can be set to trigger any time the amount of antimicrobial agent in the irrigation water exceeds the pre-determined range, or reaches a predetermined value. The amount of antimicrobial agent in the water can be measured in ppm, for example. For conventionally grown produce, the desired ppm of PAA may be around 10 ppm (e.g., within a range of 9.5 ppm and 10.5 ppm). For organically grown produce, the desired ppm of PAA may be around 5 ppm (e.g., within a range of 4.5 ppm and 5.5 ppm). These values are exemplary only and different ranges may be set as desired. The current dosage and measured ppm can be displayed on a display device of the control system, according to some embodiments. According to some embodiments, historic control and measurement data is stored and accumulated on a storage device (e.g., hard drive or memory) of the antimicrobial treatment system 100.

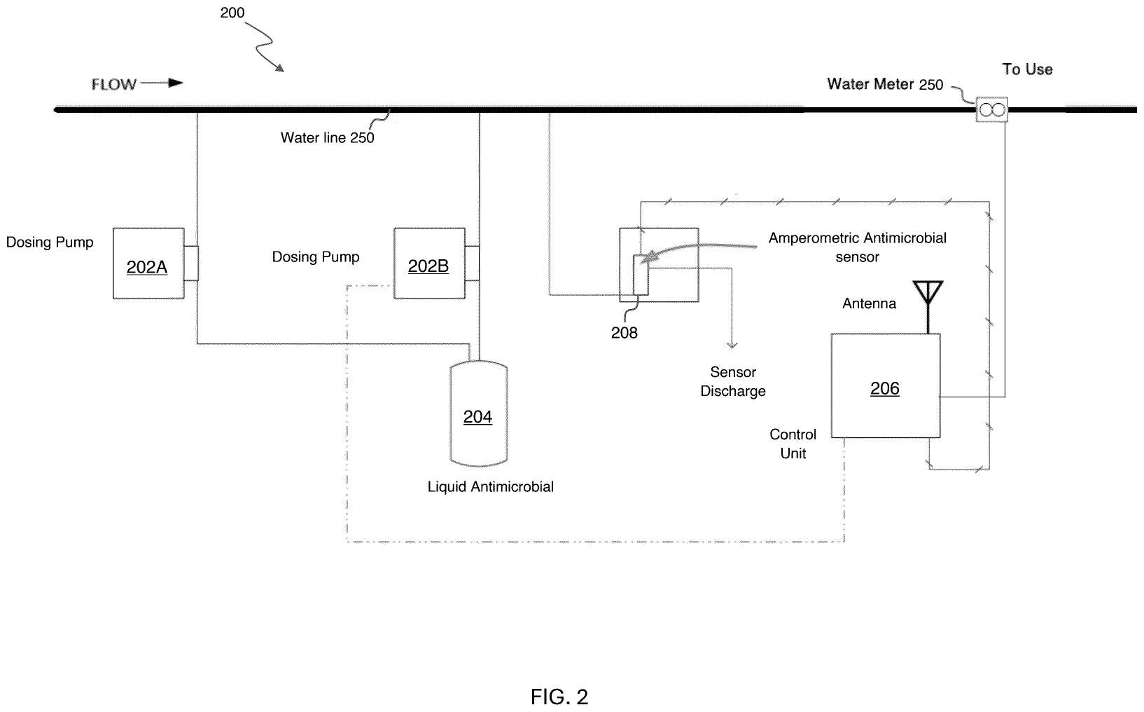

FIG. 2 is a diagram depicting an exemplary automatic antimicrobial treatment and validation system 200 including two dosing pumps 202A, 202B, and a water meter 210 according to embodiments of the present invention. Automatic antimicrobial treatment and validation system 200 is a base treatment station disposed near a main irrigation line 250, and the operations of dosing pumps 202A, 202B are controlled by control unit 206 to automatically release antimicrobial agents from liquid antimicrobial storage tank 204 into main irrigation line 250 to bring the level of antimicrobial agent in the water flowing through main irrigation line 250 to a specific level or within a specific range of acceptable values. Additionally, antimicrobial treatment and validation system 200 includes a water meter 210 that continuously measures and reports the real-time flow rate of water line 250 to control unit 206. Typically components located in close proximity ot the base station communication over a wired connection with control unit 206, e.g., water meter 210, dosing pumps 202A, 202B, and amperometric sensor 208, while more remote components can communicate with control unit 206 wirelessly using one or more radios.

In the example of FIG. 2, one dosing pump can be controlled according to readings of the amperometric sensor 208, and the other dosing pump can be controlled according to the water flow rate. For example, pump 202A can be controlled by control unit 206 to release a substantially continuous dose of antimicrobial agent at a frequency proportionate to the water flow rate determined by water meter 210, and pump 202B can be controlled by control unit 206 to release a periodic dose of antimicrobial agent based on the measured residual determined by control unit 206 (e.g., according to the measurements of amperometric sensor 208). In this way, the antimicrobial levels present in the irrigation water supply (residual) can be maintained within a desired range over time.

As mentioned earlier, additional amperometric sensors 208 can be disposed throughout the irrigation system, for example to measure antimicrobial levels (residual) at different points in the system. According to some embodiments, an end-of-the-line amperometric sensor 208 is disposed after (e.g., downstream of) the last outlet or sprinkler in the irrigation system to read antimicrobial levels after the last outlet or sprinkler to validate that the amount of residual antimicrobial agent at the end of the irrigation system is within the desired range. The additional amperometric sensors 208 typically communicate wirelessly with control unit 206, which can control one or more dosing pumps 402A, 202B according to the readings of the amperometric sensors 208.

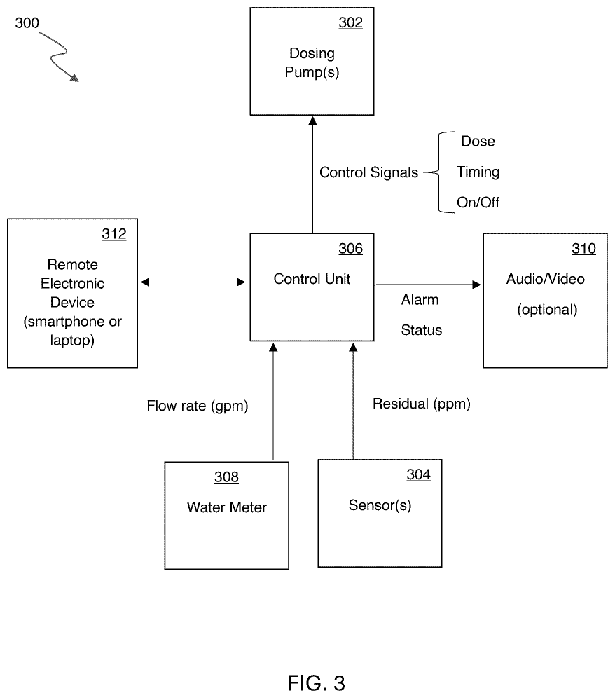

FIG. 3 is a data flow diagram depicting the commands and data communicated between exemplary devices of an automatic antimicrobial water treatment system 300. In the example of FIG. 3, control unit 306 communicates wirelessly with one or more dosing pumps 302, water meter 308, one or more sensors 304, and optionally with remote electronic device 312, which can be a smartphone, laptop, tablet, desktop computer, etc. The control unit can automatically control the function (e.g., output and timing) of dosing pumps 302 according to various factors, such as amperometric sensor readings and flow rate. According to some embodiments, control unit 706 communicates with the dosing pumps wirelessly using wireless control signals or pulses. For example, the control signals can be between 4 and 20 mA.

Sensors 304 can include multiple sensors disposed at various water lines of an irrigation system. For example, the sensors can be disposed at a midpoint or end-of-line of an irrigation line. The sensors can indicate the amount of antimicrobial agent downstream from the base treatment system to determine initial levels, and can indicate the amount of residual near the last sprinkler or outlet to determine antimicrobial content at the end of the line extending from the base treatment station. These measurements can be used to automatically control pumps 302 so that the measured residual in the irrigation system falls within the configured range, and to validate the amount of residual present at the end of the line. According to some embodiments, one or more of pumps 302 are controlled according to measurements of water meter 308 indicating the flow rate of the water line. Generally more antimicrobial agent is required when the flow rate measured by water meter 308 increases. Control unit 306 can also transmit timing or scheduling information for controlling pumps 302 (e.g., on/off hours), and can also manually activate or deactivate the pumps 302.

According to some embodiments, control unit 306 can output audio and/or video data through a speaker of connected device (e.g., a display device). The audio can include an audible alarm that is triggered by control unit 306 when the level of antimicrobial agent measured by sensors 304 falls outside of a predetermined range, or when the flow rate measured by water meter 308 falls outside of a predetermined range. The video data can include status information of the water meter 308, sensors 304, or dosing pumps 302, in the form of text, charts, images, etc.

According to some embodiments, control unit 306 can communicate with a remote electronic device 312 over a local network (e.g., Wi-Fi or Bluetooth) or via the Internet. The device 312 can receive data from control unit 306 for display or can be used to transmit control information to control unit 306, for example, to control dosing pumps, including setting limits, scheduling, manual controls (e.g., on/off), or desired residual values.

According to some embodiment, control unit 306 creates and/or maintains a database of historical data in memory, which can include sensor readings and corresponding pump commands or configurations and to validate that the irrigation system had sufficient agent throughout the system over time. The historical data can be analyzed or otherwise processed to identify correlation and trends in the historical data. Based on the analysis, the control unit can reference historical trends to determine when a dosing pump should release more or less antimicrobial agent, for example. Moreover, the historical trends can be analyzed to determine when an alarm should be triggered to indicate that the antimicrobial chemical supply has been depleted, or that a pump or sensor has failed, for example. The historical data can be analyzed by an AI machine learning algorithm, neural network, or large language model (LLM), for example. The historical data can also be transmitted to one or more of the handheld electronic devices 312.

FIG. 4 is a flowchart depicting exemplary steps of a process 400 for automatically monitoring and treating irrigation water using pumps that release an antimicrobial agent or similar chemical according to embodiments of the present invention. Process 400 advantageously maintains antimicrobial levels (residual) within a desired range according to sensor data that can monitor and can validate antimicrobial levels at various points throughout the irrigation system. For example, one or more remote sensors can be used to measure the antimicrobial residual just before or after, e.g., downstream of, the last sprinkler or outlet of the irrigation system, as well as other points throughout the irrigation system, to validate the antimicrobial residual over time in the irrigation system. The steps of process 400 can be performed by a control unit or similar device including a processor and memory that can control one or more dosing pumps and receive sensor data from one or more sensors. According to some embodiments, the control unit communicates with the pumps and sensors wirelessly over Bluetooth or Wi-Fi, for example, although wired connections can also be used (e.g., ethernet, USB, etc.). The control unit can also be in communication with a remote electronic device (e.g., smartphone, laptop, etc.) for displaying status information, configuring the control unit, or adjusting the desired antimicrobial residual, for example. The control unit can store in memory the received sensor data.

At step 402, an input indicating a target antimicrobial residual is received at the control unit. The input can be in ppm, for example, and can include a range of acceptable values. According to some embodiments, acceptable values are mapped on a scale from 1 to 5, with 1 indicating the lowest acceptable level of residual, 5 representing the highest level of acceptable level of residual, and 3 indicating the ideal level of residual. The input can be received by the control unit from a user input device of the control unit (e.g., a keyboard, keypad, touchscreen, nob, button, etc.) of from a separate electronic device in communication with the control unit (e.g., a smartphone or laptop). Other input received in step 402 can include a dosing schedule or other timing information (on/off time), for example.

At step 404, the control unit accesses sensor data generated by one or more sensors. The sensor data can be generated by an amperometric sensor that indicate the amount of antimicrobial agent present in sampled water (e.g., in ppm) or by a water meter that indicates the flow rate of an irrigation line (e.g., in gpm) and can be transmitted to the control unit by the sensors wirelessly, for example.

At step 406, the control unit generates a control command or similar signal that is transmitted to one or more dosing pumps to cause them to release a controllable amount of antimicrobial agent. Peracetic acid (PAA) is one commonly used antimicrobial chemical. Chlorine dioxide, liquid or solid chlorine without pH control, and chlorine with pH control are other suitable examples. The command can be generated based on the desired antimicrobial residual set in step 402 and/or the sensor data received in step 404. For example, the control command can cause a larger amount of antimicrobial agent to be released when the sensor data indicates that the antimicrobial residual is below the desired level, and can cause a smaller amount of antimicrobial agent to be released when the sensor data indicates that the antimicrobial residual is above the desired level. The command can also include turning the pump on or off.

Step 406 can be repeated for each dosing pump present in the treatment system, and different pumps can be configured to perform different functions. According to some embodiments, a first pump operates continuously as a frequency drive proportionate to the water flow rate, and a second pump operates periodically according to amperometric sensor readings indicating the antimicrobial residual.

According to some embodiments, a series of control commands are generated according to a dosing schedule or other timing information received in step 402. Steps 404 and 406 can be repeated continuously maintain the antimicrobial residual for any period of time.

At step 408, the control unit receives additional sensor data from a sensor to validate the antimicrobial residual at a remote point (e.g., end-of-the-line or at an intermediate/midpoint) of an irrigation line or system. If the amount of antimicrobial residual falls outside of the desired value or range of values, an alarm can be triggered to alert the user. The sensor can be disposed at the base control unit or can be a remote sensor disposed near the end of an irrigation line, for example. Steps 404 to 408 can be repeated indefinitely to continuously treat the water supply, or process 400 can return to step 402 to set a new antimicrobial residual value.

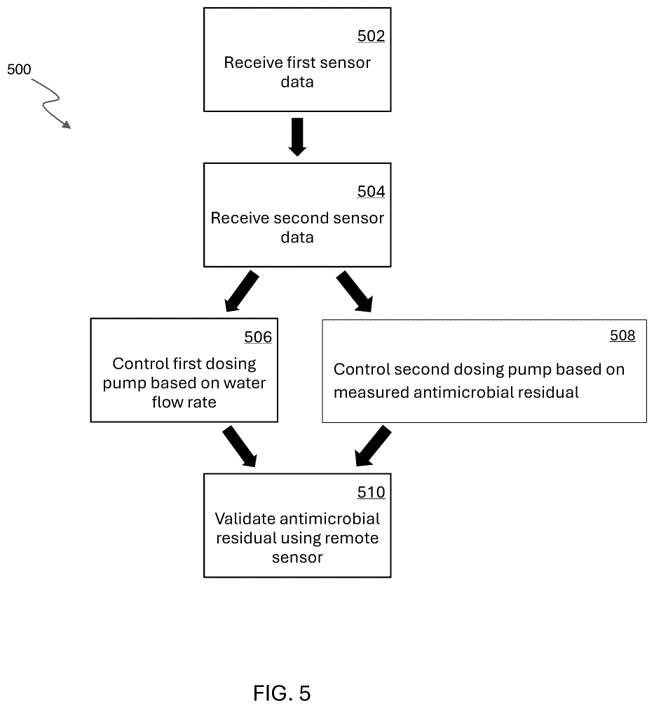

FIG. 5 is a flowchart depicting exemplary steps of a process 500 for automatically monitoring and treating irrigation water using pumps that release an antimicrobial agent or similar chemical according to embodiments of the present invention. Process 500 controls the pumps via signals or commands generated by a control unit to advantageously maintain antimicrobial levels (residual) within a desired range according to sensor data that can monitor and can validate antimicrobial levels at various points throughout the irrigation system. According to some embodiments, steps 502-508 are repeated continuously to keep the level of antimicrobial residual as consistent as possible within the desired range.

At step 502, first sensor data including a water flow rate is received at the control unit. The first sensor data can be generated by a water meter or the like. This data can be stored in memory by the control unit.

At step 504, second sensor data including an antimicrobial level is received at the control unit. The second sensor data can be generated by an amperometric sensor or the like. This sensor data can be stored by the control unit.

At step 506, a first dosing pump is controlled by the control unit to release an amount of antimicrobial agent according to the first sensor data. Step 506 can be repeated continuously to maintain antimicrobial levels within a desired range based on the water flow rate by continuously releasing controlled doses of antimicrobial agent. In other words, the first dosing pump can be operated as a frequency drive that lows down and speeds up based on the water flow rate.

At step 508, a second dosing pump is controlled by the control unit to release controlled amounts of antimicrobial agent periodically according to the second sensor data indicating the level of antimicrobial residual to maintain antimicrobial levels within a desired range. Steps 502-508 can be repeated continuously or according to a dosing schedule or the like.

At step 510, the antimicrobial residual is optionally validated using a remote sensor disposed, for example, at the end of the irrigation system. The validation can include comparing measured antimicrobial levels measured by the remote sensor to a desired value or range of values. The validation can be performed over time to ensure that antimicrobial levels are maintained within the desired range. Out of range measurements can trigger an alarm or adjustment of the dosing pumps, for example.

According to some embodiments, step 506-510 can be performed according to data from multiple sensors, including remote sensors disposed at various points of the irrigation line (e.g., at the end of the line).

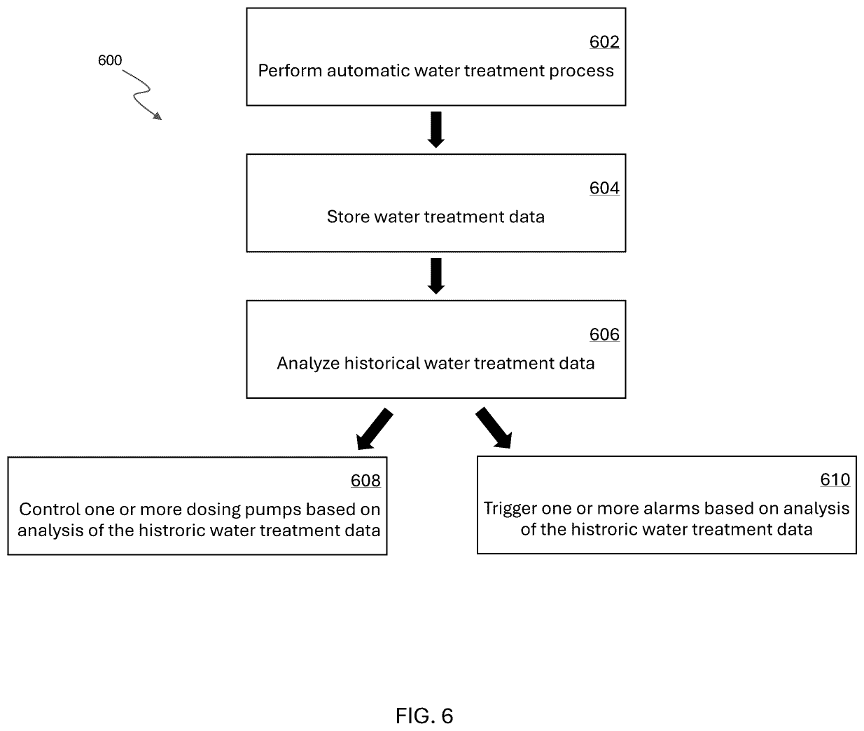

FIG. 6 is a flowchart depicting exemplary steps of a process 600 for automatically monitoring and treating irrigation water using pumps that release an antimicrobial agent or similar chemical based on historic sensor data according to embodiments of the present invention. Process 600 advantageously maintains antimicrobial levels (residual) within a desired range according to historical sensor data to reduce variations in antimicrobial residual for improved safety and agricultural production.

At step 602, a process of automatic water treatment for an irrigation system is performed. Step 602 can include controlling one or more pumps and receiving sensor data (e.g., process 400 or 500 described above). Step 602 can be performed by a control unit for example (e.g., control unit 206).

At step 604, water treatment data generated or accessed during step 602 is stored on a storage device (e.g., hard drive, memory, cloud storage or remote database). The data can include sensor readings and/or corresponding pump commands or configurations, for example. The data can be analyzed or otherwise processed to identify correlation and trends in the data, and can be added to a database of historical data stored on the storage device, e.g., for irrigation validation over time.

At step 606, the historical data stored on the storage device is analyzed or otherwise processed to identify historical trends and/or for validation. The trends can be used to determine when a dosing pump should release more or less antimicrobial agent, for example, or to determine when an alarm should be triggered to indicate that the antimicrobial chemical supply has been depleted, or that a pump or sensor has failed, for example. Step 606 can include processing the historical data using an AI machine learning algorithm, neural network, or large language model (LLM), for example. Step 606 can be repeated any time new data is stored or accessed by a control unit or other device and new pump settings/configurations can be generated based on the newly aggregated data.

At step 608, one or more pumps are controlled according to real-time sensor data and a first trend identified in step 606 based on the historical data.

At step 610, one or more alarms are triggered according to real-time sensor data and a second trend identified in step 606 based on the historical data.

### Exemplary Computer Controlled System

Embodiments of the present invention provide systems and device for performing automatic antimicrobial treatment of irrigation water by controlling one or more antimicrobial pumps according to sensor data (e.g., amperometric sensors, water meters, etc.). The following discussion describes one such exemplary electronic system or computer system that can be used as a platform for implementing embodiments of the present invention. System 716 could be the control unit and/or a remote computer system in communication with the control unit.

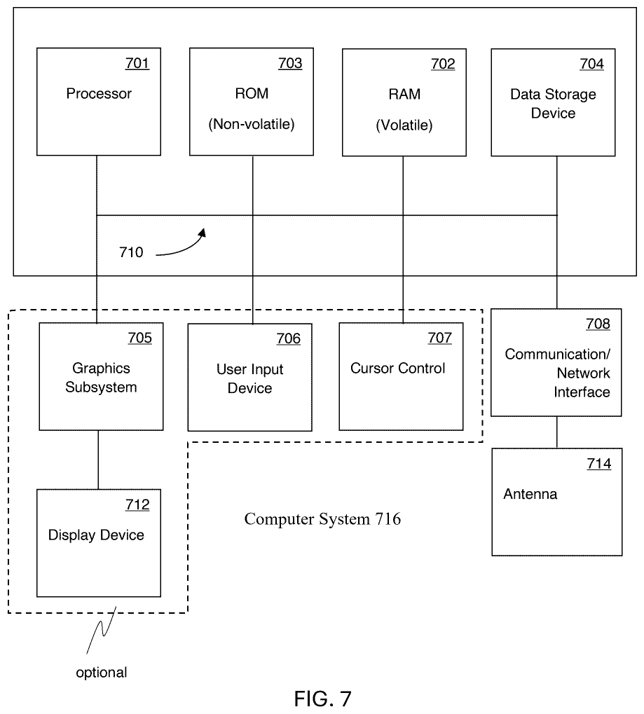

In the example of FIG. 7, the exemplary computer system 716, which can be a control unit such as a base control unit or a remote control unit, includes a central processing unit (CPU) 701 for running software applications and optionally an operating system. Random access memory 702 and read-only memory 703 store applications and data for use by the CPU 701. Data storage device 704 provides non-volatile storage for applications and data and may include network attached storage (NAS) devices, cloud storage devices, fixed disk drives, removable disk drives, flash memory devices, and CD-ROM, DVD-ROM or other optical storage devices. The data storage device 704 or the memory 702/703 can store configuration data for controlling one or more pumps, sensors, etc., and can store and accumulate historic sensor data and pump control data which can be later reviewed, processed, and analyzed to improve performance of the antimicrobial treatment system.

The optional user inputs 706 and 707 comprise devices that communicate inputs from one or more users to the computer system 712 (e.g., mice, joysticks, cameras, touchscreens, and/or microphones). The input devices 706 and 707 can be used to input a desired antimicrobial residual level or range of acceptable values, for example.

A communication or network interface 708 can include one or more radios coupled to an antenna 714 and allows the computer system 716 to communicate with other computer systems, networks, or devices via an electronic communications network, including wired and/or wireless communication and including an Intranet or the Internet. The network interface 708 can retrieve updates stored by a remote computer system or network (e.g., software updates, firmware updates, etc.).

The optional display device 712 may be any device capable of displaying visual information, e.g., the final scan report, in response to a signal from the computer system 716 and may include a flat panel touch sensitive display, for example. The components of the computer system 716, including the CPU 701, memory 702/703, data storage 704, user input devices 706, and graphics subsystem 705 may be coupled via one or more data buses 710.

Embodiments of the present invention are thus described. While the present invention has been described in particular embodiments, it should be appreciated that the present invention should not be construed as limited by such embodiments, but rather construed according to the following claims.

What is claimed is:

1. A method of automatically treating irrigation water using an antimicrobial agent, the method comprising:
receiving sensor data from an amperometric sensor disposed at a location within an irrigation system, the amperometric sensor operable to indicate an antimicrobial residual of irrigation water flowing through the location of the irrigation system;
generating a control signal for controlling a first dosing pump to release an antimicrobial agent based on the sensor data; and
transmitting the control signal to the first dosing pump to control a function of the first dosing pump, wherein the amperometric sensor is downstream from the first dosing pump within the irrigation system.

2. The method of claim 1, wherein the amperometric sensor is disposed upstream of a first sprinkler of the irrigation system.

3. The method of claim 2, further comprising validating the antimicrobial residual of the irrigation water based on the sensor data.

4. The method of claim 2, further comprising storing the sensor data in memory and validating the antimicrobial residual of the irrigation water based on remote sensor data generated by a remote amperometric sensor, wherein the remote amperometric sensor is disposed downstream of a last sprinkler of the irrigation system.

5. The method of claim 1, wherein the antimicrobial agent comprises peracetic acid (PAA), wherein the amperometric sensor comprises a PAA amperometric sensor.

6. The method of claim 1, wherein the antimicrobial agent comprises chlorine.

7. The method of claim 1, further comprising:
receiving water flow rate data from a water meter indicating a water flow rate of the irrigation water; and
generating another control signal for controlling a second dosing pump according to the water flow rate data.

8. The method of claim 7, wherein the generating a control signal for controlling a first dosing pump based on the sensor data comprises controlling the first dosing pump to release a relatively small amount of the antimicrobial agent periodically.

9. The method of claim 7, wherein the generating another control signal for controlling a second dosing pump according to the water flow rate comprises continuously releasing the antimicrobial agent at a rate proportionate to the water flow rate.

10. The method of claim 1, further comprising:
storing historical water treatment data comprising at least one of: the control signal; and the sensor data;
aggregating the historical water treatment data with existing historical water treatment data; and
analyzing the historical data to identify a trend corresponding to antimicrobial levels of the irrigation water.

11. The method of claim 10, further comprising generating a modified control signal for controlling the first dosing pump to release an antimicrobial agent based on new sensor data generated by the amperometric sensor and the trend.

12. A method of automatically treating water for irrigation using an antimicrobial agent, the method comprising:
receiving first sensor data from a first sensor operable to indicate an antimicrobial residual of irrigation water flowing through an irrigation system at a location of the first sensor;
receiving second sensor data from a second sensor operable to indicate a water flow rate of the irrigation water at a location of the second sensor;
generating a first control signal for controlling the first dosing pump to release an antimicrobial agent based on the antimicrobial residual as measured by the first sensor; and
generating a second control signal for controlling the second dosing pump to release an antimicrobial agent based on the water flow rate as measured by the second sensor.

13. The method of claim 12, further comprising storing the antimicrobial residual in memory and validating the antimicrobial residual based on the first sensor data.

14. The method of claim 12, further comprising validating the antimicrobial residual based on remote sensor data generated by a remote sensor indicating a remote antimicrobial residual level.

15. The method of claim 12, further comprising receiving a target antimicrobial level as input, wherein the generating the first control signal and the generating the second control signal comprise generating control signals that alter the amount of antimicrobial agent released by the first dosing pump and the second dosing pump to achieve the target antimicrobial level.

16. The method of claim 15, wherein the receiving a target antimicrobial level as input comprises receiving a range of acceptable antimicrobial levels.

17. The method of claim 12, further comprising triggering an alarm according to at least one of: the first sensor data; and the second sensor data.

18. A method of automatically treating water for irrigation based on historic treatment data, the method comprising:
performing an automatic water treatment process comprising automatically controlling a dosing pump based on real-time sensor data indicating a level of antimicrobial residual flowing through an irrigation system;
storing data generated by the automatic water treatment process;
aggregating the data generated by the automatic water treatment process with historical water treatment data; and
analyzing the historical water treatment data to determine a trend corresponding to dosing pump control commands and the real-time sensor data.

19. The method of claim 18, further comprising:
receiving new real-time sensor data; and
controlling the dosing pump using control commands generated according to the trend and the new real-time sensor data.

20. The method of claim 18, further comprising:
receiving new real-time sensor data; and
triggering an alarm according to the trend and the new real-time sensor data.
